(19) United States
(12) Patent Application Publication
(10) Pub. No.: US 2025/0363498 A1
(43) Pub. Date: Nov. 27, 2025

(54) SYSTEMS AND METHODS FOR FACILITATING PRODUCT RETURNS

(71) Applicant: The Chamberlain Group LLC, Oak Brook, IL (US)

(72) Inventors: Casparus Cate, Murfreesboro, TN (US); James Joseph Fitzgibbon, Batavia, IL (US); James D. Johnson, Algonquin, IL (US); Jonathan Lee, La Grange, IL (US); Tyler Lenczuk, Chicago, IL (US); David R. Morris, Glenview, IL (US); James Scott Murray, West Chicago, IL (US)

(21) Appl. No.: 18/082,310

(22) Filed: Dec. 15, 2022

Related U.S. Application Data
(60) Provisional application No. 63/295,217, filed on Dec. 30, 2021.

(51) Int. Cl. G06Q 30/016; G07C 9/00

(52) U.S. Cl. CPC G06Q 30/016; G07C 9/00896; G07C 2009/00928

(57) ABSTRACT

A method and control circuit are provided for facilitating a return of a product from a garage. The control circuit includes communication circuitry configured to communicate with a sensor and a processor configured to control the communication circuitry to receive a return request associated with a user account for returning a product, and data from the sensor indicating whether the product is in a designated return zone of the garage. The processor is configured to authorize the return request in response to a determination of the product having been ordered using a user account and a determination that the product is in the designated return zone. The processor is further configured to control the communication circuitry to receive a request for a return agent to retrieve the product from the garage by enabling the return agent to control a garage door operator to access the garage and retrieve the product.

### CROSS-REFERENCE TO RELATED APPLICATION

This application claims the benefit of U.S. Provisional Patent Application No. 63/295,217, filed Dec. 30, 2021, entitled Systems and Methods for Facilitating Product Returns, which is incorporated by reference in its entirety herein.

### FIELD

This application relates to return of a received item from a secure area and, more specifically, to pick-up of an item from a secure area for transportation to the seller or a holding facility and reimbursing a purchaser of the item.

### BACKGROUND

Some retailers provide delivery of purchased, requested, and/or ordered items to customers. In the event that the recipient is dissatisfied with the purchase or otherwise wishes to reject the item and obtain a refund of a purchase price for the item, the purchaser or recipient transports the item to a physical retail location or repackages the purchased item, prints a return label, and transports the item to a post office or other shipping facility.

Some retailers allow purchasers to schedule pickup of returned items from the purchaser's home. These approaches may have a variety of drawbacks, such as requiring the purchaser to be at home when the pickup takes place, permitting a delivery person access to an interior of the purchaser's home, leaving the returned items out in the open where they may be stolen, or depositing the items in a relatively small space or a visually unappealing compartment accessible from the exterior of the purchaser's home. Purchasers generally do not have a return mechanism that is comparable in convenience to online shopping, and retailers do not have a cost-effective return process for collecting returned items directly from customers.

### BRIEF DESCRIPTION OF THE DRAWINGS

FIG. 1 is a perspective view of an example of a garage containing a movable barrier operator and designated return zone;

FIG. 2 is a diagrammatic plan view of another example of a garage containing a movable barrier operator and designated return zone;

FIG. 3 is a block diagram illustrating one example of a system for facilitating returns;

FIG. 4 is a flow diagram of an example method of facilitating an item return transaction; and

FIG. 5 is a flow diagram of an additional example method of facilitating an item return.

### DETAILED DESCRIPTION

Systems and methods are provided for facilitating the return of purchased or received items from the convenience of the home of a user, such as a recipient or purchaser, or another convenient location. In one embodiment, a system is provided that includes a movable barrier selectively movable to open and close an access point to a secure area (such as an attached or detached garage), a movable barrier operator coupled to the movable barrier and configured to shift the movable barrier in response a message received from a mobile device, and a designated return zone (such as an identifiable portion of the secure area, a mat, or a storage unit) positioned within the secure area and accessible when the movable barrier is shifted to an open or partially open position.

In some forms, the system may be configured to contact the nearest available return agent relative to the secure location and provide the return agent with instructions regarding identification and location of the merchandise to be returned. In some other forms, the system may further include or be in communication with a return agent network. Utilizing the return agent network, the system may obtain data regarding a plurality of return agents and select a designated return agent from the plurality of return agents based on information from the return agent network. In some forms, the return agent may be selected based on a variety of criteria, including information regarding a current location of the return agent or a scheduled future location of the return agent. For instance, the system may contact a return agent who is within, or scheduled to be within, a preset proximity to the secure area. In some forms, the system may determine if a return agent is scheduled to make a delivery to, or retrieve another return from, the secure area or another area within a predetermined distance of the secure area. In some forms, the system selects a return agent based on that return agent's association with a number of scheduled returns and/or deliveries, or timing of scheduled returns and/or deliveries, within a predetermined distance of the secure area. For instance, the system may select a return agent who is scheduled to make more deliveries within a specific area and time window than other available agents in order to increase efficiency of the return process. In some forms, the return agent may be an unmanned vehicle, such as an aerial or land-based drone or robot, or a fleet of drones or robots.

In some forms, the system also compares information regarding an item placed in the storage unit to information regarding a purchase history associated with the secure area, or a purchase history associated with an individual who initiated the return process, in order to confirm that the item scheduled to be returned was actually purchased from a given seller. Upon retrieval of the item, the system in some forms may automatically issue a full or partial monetary refund or store credit to the purchaser.

In some forms, a system for facilitating the return of purchased items comprises a movable barrier selectively movable to open and close an access point to a secure area; a movable barrier operator coupled to the movable barrier and configured to shift the movable barrier in response to a message from a mobile device; a storage unit positioned within the secure area; and a control circuit configured to provide temporary or limited-use access between the mobile device and the movable barrier operator when an item return transaction is initiated.

In some forms, the control circuit is a remote server, the message is sent from the mobile device to the server, and the server issues commands to the movable barrier operator. In some forms, the storage unit is lockable and the server also unlocks the lockable storage unit in response to the message from the mobile device. In other forms, the mobile device sends the message directly to the movable barrier operator. In some forms, the message from the mobile device comprises a temporary or limited-use access code. The term “access code” will be understood to include one or more access codes or groups of codes. In some forms, the control circuit of the system is further configured to provide a second temporary or limited-use access code to the mobile device, the second temporary or limited-use access code configured to unlock the lockable storage unit. In other forms, the temporary or limited-use access code is configured to shift the movable barrier and also unlock the lockable storage unit. In some forms, the message from the mobile device comprises the first temporary or limited-use access code and second temporary or limited-use access code. In some forms, the control circuit is configured to transmit the first temporary or limited-use access code to the movable barrier operator and the second temporary or limited-use access code to the lockable storage unit upon receipt of the message from the mobile device. In some forms, the control circuit is configured to respond to communications from the mobile device only within a preset time window. In some forms, the control circuit is configured to respond only to a specific number of messages from the mobile device.

In some forms, the control circuit is in communication with a return agent network, the control circuit further configured to obtain data regarding a plurality of return agents from the return agent network and select a designated return agent from the plurality of return agents based on information regarding a current location or scheduled future location of the designated return agent, the current location or scheduled future location being within a preset proximity to the secure area. In some embodiments, the control circuit selects the designated return agent based on at least one scheduled delivery to the secure area. In other embodiments, the control circuit selects the designated agent based on the designated return agent being associated with a number of scheduled returns or deliveries within a predetermined distance of the secure area, the number of scheduled returns or deliveries exceeding a preset threshold. In some forms, the control circuit is further in communication with a retail network and configured to compare information regarding merchandise placed in the lockable storage unit to information regarding a purchase history associated with the secure area. In some forms, the control circuit is further in communication with a financial network and configured to authorize a refund upon confirmation that merchandise placed in the storage unit has been retrieved.

In some forms, the lockable storage unit of the return system comprises one or more sensors to identify an item when the item is placed in the storage unit, and where identification of the item causes the control circuit to issue a request to a return agent for retrieval the item. In some embodiments, the control circuit of the system is configured to issue the request to the return agent only upon confirmation that the item matches an entry from a purchase history associated with the secure area.

Methods for facilitating the return of an item are also provided. In some methods, a control circuit receives information associated with an item to be returned to a seller, including confirmation that the item has been placed within a designated return zone of a secure area. Information regarding the item and the location of the designated return zone in which the item has been placed is transmitted to a mobile device associated with a return agent assigned to carry out the return transaction. One or more temporary access codes are provided to the mobile device of the return agent, and the temporary access codes are transmitted by the mobile device directly or indirectly to a movable barrier operator located at the secure area. The movable barrier shifts a movable barrier in response to receipt of at least one of the temporary access codes from the return agent's mobile device to permit the return agent to access the secure area. The return agent may provide confirmation that the item has been removed from the designated return zone, or alternatively a sensor associated with the designated return zone may provide confirmation that the item has been removed.

In some methods, a second barrier controlling access to the designated return zone is unlocked and/or shifted in response to receipt of a second temporary access code received from the mobile device. For instance, the designated return zone may be a closet, cabinet, or other enclosed or partially enclosed storage unit.

Facilities, systems, and logistics are provided herein for scheduling pickup of rejected items. While various embodiments are discussed with reference to a purchaser or seller, the same systems and methods may be applied to persons other than a purchaser (such as the recipient of items purchased by another, a family member of the purchaser/recipient, an agent of the purchaser/recipient, a user who has redeemed points or other credit, the recipient of a trade facilitated by an online marketplace, or other users) and/or seller (such as an agent of the seller, a resale officer, a third party purchaser or returned items, or other users). A purchaser of an item may grant a return agent (e.g. an authorized agent of the retailer from which the item was purchased) temporary access to a return zone from which the agent may retrieve the item to be returned. The agent may be, for instance, an employee of the seller, a third-party parcel carrier, a crowdsourced contractor designated to retrieve the items, or another person or entity acting on behalf of the seller. Alternatively, a return agent designated to retrieve a returned item from the purchaser may be an agent of the purchaser or an agent of an intermediary and contracted to deliver the returned item into the possession of the seller. In some forms, the secured designated return zone from which the return agent retrieves the returned item is a residential garage that is detached from or attached to the purchaser's or recipient's home, a portion thereof, or another portion of the purchaser's home, with the designated return zone secured by a movable barrier operator such as a garage door opener that may be activated only by those with a required security code and/or device with encryption technology compatible with the movable barrier operator. The purchaser may grant the retailer's agent access to the secured return zone through a variety of methods, including use of portable transmitters (such as designated handheld control devices, smartphones, or the like) or stationary devices (such as mounted keypads or transmitters).

In some forms, a user schedules an item to be picked up and returned to the seller from which it is received and/or purchased. It will be understood by those of ordinary skill in the art that although specific embodiments herein may indicate that the seller is a retailer, the systems and methods described are equally applicable to wholesalers, suppliers, individual sellers, and other persons and entities that sell or otherwise provide physical items. In some forms, a purchaser or recipient initiates a return transaction for a rejected item and places the returned item in a convenient secured location (such as a garage attached to their home), and a return agent is able to access the secured location in order to retrieve the returned item and transport the returned item to a final return destination in order to carry out a return transaction. The purchaser may then obtain a refund for the purchase of the item, and in some forms may receive the refund electronically at the time that the returned item is retrieved by the agent or the time that the agent delivers the returned item into the seller's custody. In alternative embodiments, a user may scan an item or take a picture of the item, in some embodiments using a mobile application on their smartphone or other mobile device, and then transmit an image of the item or other information to a server that initiates the return procedure. In some such embodiments, the user would also provide information regarding the location of the item to be returned through their smartphone or other mobile device. The purchaser is thus able to initiate a return process from his or her home without any need to transport the returned item to a shipping facility or location designated by the seller, and there is no need for the purchaser to be present when the seller's agent arrives to retrieve the returned item.

In some forms, a user initiates a return transaction by sending an electronic message indicating the identities of the purchaser and the item to be returned. In some instances, the sending of this message may include manually entering information regarding the purchaser and item to be returned, such as through a user device including a personal computer, smartphone, or other electronic device. The user may alternatively convey the information in another manner, such as by using a telephone to call an agent or automated call center of the seller and audibly initiating the return transaction. In other forms, the user may automatically initiate a return transaction by placing an item to be returned in a designated return zone. The designated return zone may be an open or enclosed space, and may be associated with one or more sensors or other devices to identify the item. For instance, if an item to be returned includes a product code, such as a bar code, QR code, or the like, a code reader may be placed in or near the return zone so that an item return system automatically initiates a return transaction upon scanning of the product code within the designated return zone. In other forms, a pressure sensor, such as a piezoelectric mat, may detect the presence of an item within the designated return zone and initiate a return, with the item in the return zone identified either by the purchaser, by a return agent upon retrieval, or through equipment such as a camera coupled to product recognition software configured to identify purchased merchandise.

Once a return transaction is initiated, a return agent is contacted to retrieve the item from within the designated return zone. The return agent may be selected by the user, the seller, or by the return system. In some forms, the return system selects the return agent through a selection algorithm, such as by taking into account information that may include proximity to the designated return zone, pre-existing affiliation with or sponsorship by the user or seller, association with similar return transactions within a designated area, or other information.

In some forms, temporary or one-time/limited-use access to the designated return zone can be granted to the return agent by establishing and providing a temporary or limited-use entry code or access token. For instance, the code provided to the return agent may be valid only for a specific amount of time or during a preset time window, or the code may be valid for only one activation cycle (e.g. opening and closing or unlocking then locking) of a barrier that limits entry to the designated return zone. The return agent then uses the temporary or limited-use entry code to gain access to the designated return zone, for instance by transmitting the code to a movable barrier operator or by entering the code into a stationary keypad near an entrance to the designated return zone. In some forms the temporary or limited-use entry code may differ from the code used by residents to access the designated return zone. In one example, the temporary or limited-use code may be configured to activate a movable barrier operator in the form of a garage door operator (also known as a garage door opener or GDO) but not configured to unlock or move a second barrier such as a door leading to the interior of a house adjacent to the garage or a door leading to a secure subsection of the garage. The return agent may utilize the temporary or limited-use code by sending a control signal including the code from a control device. The control device may be any type of device capable of activating the GDO, either directly (e.g. by transmission of a signal to the GDO using one or more frequencies, channels, bands, radio physical layers, and/or protocols, including but not limited to, for example, 300 MHz-400 MHz, 900 MHz, 2.4 GHz, Wi-Fi/WiLAN, Bluetooth®, Bluetooth Low Energy® (BLE), ZigBee, 3GPP GSM, UMTS, LTE, LTE-A, SG NR, proprietary radio, infrared (IR), hard-wire connections, and others) or indirectly (by transmitting the code to an external system including a remote computer, server computer, cloud-based computing network, cellular network, satellite network, or other platform that is in communication with the GDO). The control device may take any form suitable for communication with the GDO system, including a wireless transmitter such as a visor-mounted transmitter, a fixed transmitter such as a keypad, or a multi-purpose portable electronic computing device such as a smartphone.

In some systems, the GDO system authenticates the control signal from the control device and confirms that the control signal has been received within an appropriate time period (in the case of a temporary code) and/or that the code contained in the control signal has not been previously used to activate the GDO more than a preset number of times (in the case of a limited-use code). In some forms, the GDO system also determines whether the received control signal is a primary signal (associated with access to a secured area beyond the garage door) or a secondary signal (associated with a more limited level of access) based at least in part on a code portion (e.g., a fixed identification (ID) code that uniquely identifies the remote control or transmitter) contained in the control signal.

In other examples, a primary signal may be intended for return agents, allowing access to the garage interior as well as a container or area within the garage serving as a designated return zone, while the secondary signal is intended for delivery agents and provides a lower level of access that allows access to the garage but not access to the designated return zone. In this way, the user's garage may be accessed by multiple individuals that are granted temporary access while ensuring that those individuals do not have more access than necessary to carry out tasks for which they have been granted access to the garage. For instance, delivery agents can be permitted to access a garage in order to drop off parcels without the ability to access parcels designated for returns, while a return agent can access both the garage and a subsection or container within the garage containing the return parcel. It is also possible to provide multiple different types of primary signals (such as where both a designated delivery zone and a designated return zone are secured and unlocked by only one of a plurality of signal types in order to prevent return agents from accessing recently-delivered parcels and prevent delivery agents from accessing return parcels). Additional signals and corresponding levels of access may also be configured. In some forms, the movable barrier operator moves the garage door a first distance (e.g., fully opens the garage door) in response to a first signal type and opens the garage door a second, shorter distance (e.g., just far enough to deposit or retrieve a package) in response to a second type of signal. Signals may include information regarding how far the movable barrier operator should open the garage door, how long the door may be opened, what time of day the door may be opened, or other information. Thus, access to the door may be conditioned on a variety of criteria and/or situations.

In some forms, the designated return zone may include an enclosed area such as a storage unit. The storage unit may be temperature controlled, such as a refrigerator unit for the return of perishable food items. Additionally, or in the alternative, the storage unit may have other environmental control properties, such as humidity control, depending on the types of merchandise intended to be placed in the storage unit. The storage unit also may include a variety of sensors to determine the presence and/or condition of merchandise placed therein. Examples of suitable refrigerated storage units are described in detail in U.S. patent application Ser. No. 17/741,620, filed May 11, 2022, which is hereby incorporated by reference as if fully set forth herein. In one embodiment, the storage unit has a lock with an unlocked configuration that permits access to an interior of the storage unit and a locked configuration that inhibits access to the interior of the storage unit.

Return transactions utilizing methods and systems according to various aspects described herein may be monetized in various ways. For instance, a predetermined amount of currency or other funds optionally may be charged to the purchaser, seller, or other party facilitating the return for each transaction or each instance of accessing of a movable barrier operator and/or lock. In one example, once rejected merchandise is retrieved by a return agent the purchaser is refunded the purchase price of the merchandise less a transaction fee. In other examples, the seller is charged the transaction fee upon retrieval of the merchandise, return of the merchandise to the custody of the seller, or another condition. In some instances, multiple transaction fees may be charged and/or paid upon fulfillment of specific milestones. In other instances, the merchandise may not be returned to the seller, and could, for instance, be sent to a third-party reseller that in some situations is charged the transaction fee for use of the movable barrier operator.

Further details will be discussed in connection with various embodiments, and aspects from one embodiment may be added to or interchanged with aspects of other embodiments as desired. Various aspects may also be removed from the described embodiments.

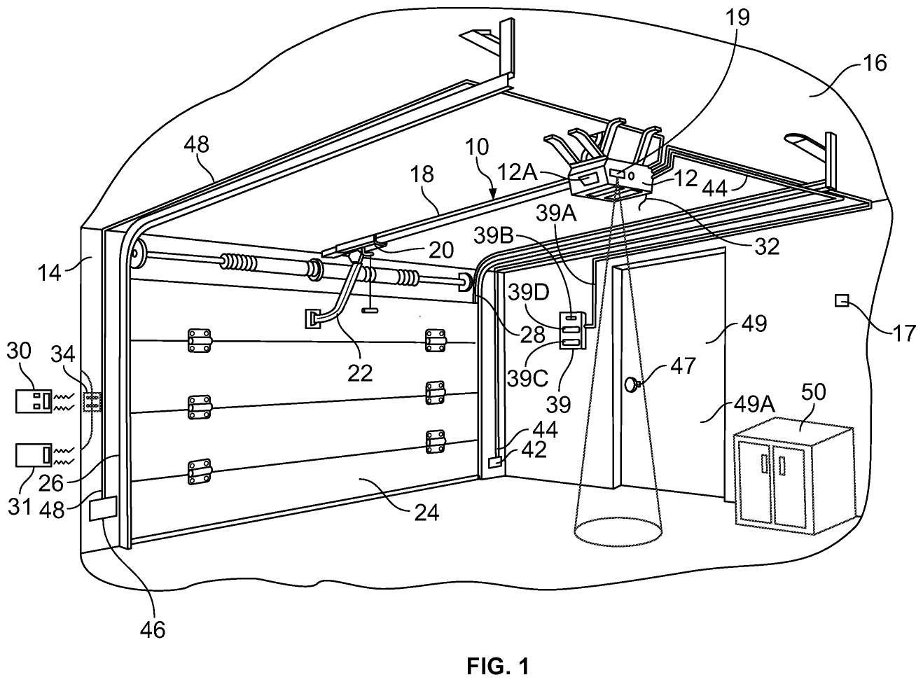

FIG. 1 illustrates a secure area, in this example garage 14, configured for use in methods for carrying out return transactions. The garage has an access system 10 including a movable barrier operator 12 mounted within the garage 14. The movable barrier operator 12 is mounted to a ceiling 16 of the garage 14 and includes a rail 18 extending therefrom with a releasable trolley 20 coupled thereto, the trolley 20 having an arm 22 extending to a multiple panel garage door 24 positioned for movement along a pair of door tracks 26 and 28. The movable barrier operator 12 includes a motor 12A coupled to the door 24 by the trolley 20 and arm 22, permitting the motor to move the door 24 up and down along the door tracks 26 and 28. The system 10 also includes remote controls such as hand-held transmitter units 30 and/or 31, the hand-held transmitter units configured to send signals for reception by communication circuitry of the movable barrier operator 12. The movable barrier operator 12 may include an antenna 32 for facilitating reception of signals from transmitter units 30, 31. In the alternative, or in addition to, the one or more hand-held transmitters, the system may include an external mounted control pad 34 having an interface (e.g. buttons, a touch screen, etc.) that can be accessed by persons located outside the garage. The external control pad 34 communicates signals via radio frequency transmission, a hard-wire connection, or other means to the movable barrier operator 12. A switch module 39 is shown mounted on an interior wall of the garage 14 and physically connected to the movable barrier operator 12 by one or more wires 39A, although the switch module 39 may alternatively communicate with the movable barrier operator 12 wirelessly or via a combination of wired and wireless signals. The illustrated switch module 39 includes a light switch 39B, a lock switch 39C, and a command switch 39D. An optical emitter 42 is connected via a power and signal line 44, or alternatively via wireless connection, to the movable barrier operator 12. An optical detector 46 is connected via a wire 48, or alternatively via a wireless connection, to the movable barrier operator 12. The optical emitter 42 and the optical detector 46 cooperate such that the garage door does not close on an object located in the path of the door, and may be combined into a single unit such as a retroreflector.

The access system 10 also may include a sensor such as a wired or wireless camera 17 positioned to capture image data such as pictures, video, within the garage 14. The camera 17 also may include a microphone for capturing audio data, and may be configured to continuously capture security data or may be coupled to a motion sensor or other detector to capture still or moving images only upon certain conditions. The camera may in some embodiments include a timer and may be configured to capture images within a preset time window after each activation of the movable barrier operator 12 or during the time between when the garage door 24 is raised and lowered. The camera 17 may in some forms be used to confirm that a return agent entered the garage 14 and traveled toward, or within a preset distance from, a storage unit 50 that serves as a dedicated return zone. The camera 17 may also be used to confirm that the return agent exited the garage before closing the garage door 24.

In some forms, the camera 17 is dynamically adjustable (e.g., a pan-tilt-zoom ‘PTZ’ camera) such that a user viewing a video stream from the camera 17 via a device such as a smartphone can configure or adjust the camera 17 to change the field of view. The access system 10 includes an adjustable indicator 19 for indicating a position within the garage 14. The indicator 19 may be integral with or independent from the movable barrier operator 12. The indicator 19 projects light, such as a cone of light, to illuminate an area. For example, the indicator may be positioned to illuminate a designated return zone or designated delivery zone, drawing the attention of a return agent or delivery agent. The indicator 19 also may include one or more lightbulbs and/or LEDs directed to form an indicium such as text, a cone, a pyramid, a circle, an arrow, and/or a rectangle on a surface such as the floor of the garage 14 to indicate a designated return zone. Rather than pointing downward from the movable barrier operator 12 as shown, the indicator also may be directed to an area along the perimeter of the garage, such as a wall or corner, or toward storage unit 50. Alternatively or additionally, the indicator 19 may comprise a laser to display one or more shapes or other indicia on a surface such as a small circle, a rectangle, an arrow, and/or lettering on the floor or a wall of the garage 14, or directly on the storage unit 50. The indicator 19 may alternatively or additionally include a speaker and/or a display screen to indicate a desired drop-off location or a designated return zone. The indicator may be positioned at a location remote from the movable barrier operator 12, for instance on or above storage unit 50, and need not be connected to the access system 10. Alternative indicators may include a flashing light, auditory signal, or other indicator originating from the designated return zone, such as storage unit 50, signage on the floor or wall of the garage, symbols or colors, or other indicia alerting a return agent as to the location of rejected merchandise to be returned. In embodiments where the garage includes both a designated return zone and a designated delivery zone, separate indicators may alert delivery agents and return agents to the appropriate zone.

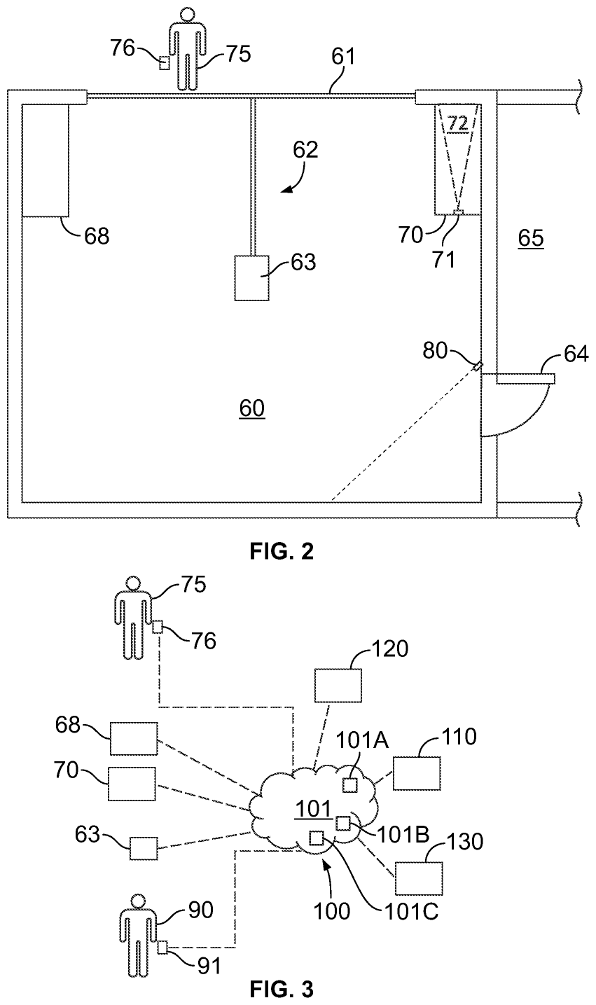

FIG. 2 is a diagrammatic plan view of a garage that includes an access system 62 configured to manipulate a movable barrier 61 in a similar manner as described above in connection with FIG. 1 so that an operator 63 moves the barrier 61 between open and closed positions when the operator 63 is activated. The garage includes a designated delivery zone 68 and a designated return zone 70. An agent 75 of a seller who has been assigned to deliver and/or retrieve an item from a user associated with the garage 60 may approach the garage 60 and utilize a mobile device 76 to present one or more temporary access codes directly or indirectly to the operator 63 and one or both of delivery receptacle 68 and return receptacle 70. Delivery receptacle 68 and return receptacle 70 may each be an open structure such as a mat, bin, shelf, shelving unit, or the like, but in some forms are enclosed and structures such as lockers, cabinets, closets, or the like. Receptacles 68 and 70 may include locks of the type described in U.S. Pat. No. 11,055,942, which application is hereby incorporated by reference as if fully set forth herein, which may be activated remotely by transmission of access codes thereto. Delivery receptacle 68 and return receptacle 70 may be the same type of structure, or may be different structures, and may in some forms be color-coded so that they are easily identifiable and distinguishable to return agents and delivery agents. The movable barrier operator 63 of FIG. 2 includes a control circuit and a memory (e.g., an internal memory or an external memory in communication with movable barrier operator 63), and the control circuit receives one or more of the temporary access codes and compares them to information stored in the memory of the movable barrier operator 63 to determine if the one or more temporary access codes are associated with specific permissions indicating that the agent has been granted permission to access the garage 60. Similarly, the agent's portable device 76 may transmit one or more codes directly or indirectly to a control circuit controlling access to the delivery receptacle 68 and/or return receptacle 70. The movable barrier operator 63, delivery receptacle 68, and return receptacle 70 may each be controlled by a separate control circuit, or may be controlled by a single master control circuit. In some forms, the permissions limit the temporal periods, e.g., times of day during which the movable barrier operator 63 will open the garage door 61 in response to receiving the one or more temporary access codes. The permissions may also indicate whether or not the temporary access code(s) grant access to the interior 65 of the attached house, the delivery receptacle 68, the return receptacle 70, or other elements of the garage 60. In some forms, an optical sensor 80, e.g., a camera or motion sensor, or other device may be positioned near the interior door 64 to detect if the agent 75 or another person approaches the interior door 64 when the garage door 61 has been opened using a temporary access code that is not associated with permissions indicating that access to the house interior 65 should be granted. The optical sensor 80 or other device is positioned in a manner so that cars parked within the interior of the garage will not prevent the detection of a person approaching the interior door 64.

The return receptacle 70 shown in FIG. 2 may include at least one sensor 71 to detect the presence and/or condition of an item placed in the return receptacle 70. For instance, the sensor 71 may include an optical sensor (such as a camera and/or barcode scanner), weight sensor, temperature sensor, and/or other sensor configured to detect the presence of an item in the return receptacle 70 in order to confirm that the item is ready for return. In some forms, the item may be associated with a tag or label, such as an active or passive RFID tag, Bluetooth® tag, GPS tag, bar code, QR code, etc. that is detected by an appropriate sensor or reader. Detection of an item in some forms may automatically trigger a return request through a control circuit associated with return receptacle 70. In other forms, a user, such as a purchaser, manually requests pickup of a return via a smartphone, personal computer, telephone, or other device, and the sensor 71 merely confirms that an item has been placed in return receptacle 70 before a return agent 75 is dispatched to retrieve the item.

In some forms, the sensor 71 may be configured to confirm that the item detected within the return receptacle 70 is the same as the item identified for being returned. In one embodiment, the sensor 71 includes a camera within return receptacle 70 coupled to optical recognition software capable of comparing the visual appearance of the item in the return receptacle 70 to images from a database of known purchases by the purchaser. In addition or alternatively, sensor 71 may include one or more sensors configured to obtain information to confirm that the item to be returned has not been damaged, destroyed, disassembled, consumed, or otherwise placed in a condition unsuitable for subsequent use. For instance, if the item to be returned is produce or another type of food item, a piezoelectric mat or other weight sensor may confirm that the item placed within the return receptacle 70 is approximately the same mass, volume, shape or size as when purchased by the purchaser, and/or visual evidence may be used to confirm that the item is intact. As a result, the item may be identified and returned even without its original packaging.

FIG. 3 is a block diagram illustrating one example of a system 100 including a return management control circuit 101 for facilitating a return process. In one embodiment, the return management control circuit 101 is a computer remote from the movable barrier operator 63, such as a server computer or a cloud-based computing network. The return management control circuit 101 includes a processor 101A such as one or more microprocessors or central processing units, a memory 101B such as a hard disk drive, RAM/ROM, and/or a solid state drive, and communication circuitry 101C such as a Wi-Fi interface, ethernet interface, and/or fiber optic communication cable interface.

A user 90 such as a recipient or purchaser contacts the return management control circuit 101 via a computing device 91 to initiate a return transaction, indicating the nature of the return or selecting the item to be returned from a list of known purchases through an application installed on the computing device 91, a website accessed by the computing device 91, or another approach for communicating with return management control circuit 101. Alternatively, and as previously described, detection of an item within return receptacle 70 may initiate a return transaction. In some forms, the user's computing device 91 can communicate with the movable barrier operator 63, delivery receptacle 68, and/or return receptacle 70 directly or indirectly such as via a cellular network, the internet, a server computer, a Wi-Fi network, and/or a wired connection.

Once a return transaction has been initiated, the return management control circuit 101 contacts a return agent 75 through an associated mobile device 76 and assigns the return agent to retrieve one or more items held within the return receptacle 70. A retrieval task including identification of one or more items to be retrieved, the location of the items, special instructions to be followed during retrieval of the items, handling instructions for the items, and other relevant information may be generated by the return management control circuit 101. Assignment of the retrieval task to a specific return agent 75 may be predicated on one or more conditions, for instance verification that an item is present in the return receptacle 70, verification that the item is intact, verification that the return receptacle 70 has been locked or sealed to prevent subsequent tampering with the item, or a variety of other conditions. In some forms, the return management control circuit 101 may only assign a retrieval task to the return agent 75 if the agent has other tasks to be completed within a preset proximity to the return receptacle 70. For instance, the return management control circuit 101 may determine which return agents from a plurality of available return agents have already been assigned retrieval or delivery tasks to neighboring dwellings. The return management control circuit 101 may also determine if a return agent 75 has been assigned to deliver merchandise to a delivery receptacle 68, or retrieve merchandise from the return receptacle 70, of the same residence. If the return is not urgent, such as where merchandise to be returned is not perishable, the return management control circuit 101 may wait to assign a return agent until a specific number of other return/delivery tasks, or a number of return/delivery tasks involving merchandise that in the aggregate exceeds a preset value, are available to be assigned to the same return agent 75. In some forms, the return agent's mobile device 76 can communicate directly with the movable barrier operator 63, delivery receptacle 68, and/or return receptacle 70 directly (e.g. a peer-to-peer connection such as Bluetooth, NFC, infrared, etc.) or indirectly such as via one or more of a cellular network, the internet, a server computer, a Wi-Fi network, and/or a wired connection, and in some cases may eliminate return management control circuit 101.

A returned item may be associated with various rules in order to properly assign agents. For instance, the return management control circuit 101 may include an item database that associates one or more rules with specific items or item types. Items may in some forms be associated with one or more item characteristics, each item characteristic further associated with one or more predefined rules for selecting a return agent. Perishable items may, for example, be associated with rules that select return agents primarily based on availability or fastest return time, and de-emphasizing the number of other returns that a return agent is capable of making within a general location. In another example, fragile merchandise may be associated with rules that select return agents at least in part based on the capabilities of return agents, avoiding agents who travel by bicycle or who have a poor performance in returning merchandise intact. Size, weight, or amount of items may also be a factor in selecting the return agent, with returned items only assigned to agents associated with a vehicle with dimensions capable of receiving the specified item (also taking into account the weight and/or volume of other items returned from the same or other users).

In some forms, item characteristics may be provided as tags associated with specific rules for selecting agents, with multiple tags capable of being associated with a single item. In one example, a “perishable” tag may filter a list of potential return agents to eliminate those that are estimated to arrive at a return facility outside of a preset time period. In another example, an “oversized” tag may filter the list of potential return agents to those driving trucks or sport utility vehicles, eliminating any potential agents travelling in small cars or trucks. A “valuable” tag may filter the list to identify return agents that have exhibited a certain amount of trustworthiness according to various factors. Algorithms may also be provided in order to provide more weight to certain characteristics in the selection of a return agent. For example, time of return may be the highest priority for perishable items, even though other factors are also taken into account.

Prior to assigning a retrieval task to the return agent 75, the return management control circuit 101 may in some forms communicate with a retail partner network 110 to verify that the item to be retrieved from the return receptacle 70 was purchased by the purchaser 90 who initiated the return transaction (or a purchaser who is affiliated with the return receptacle 70 that automatically initiated the return transaction). The retail partner network 110 may include, for example, one or more control circuits such as one or more server computers. The return management control circuit 101 may also communicate with an agent network 120 to obtain information regarding available return agents, such as location of various agents, tasks assigned to agents, pre-planned delivery or retrieval routes assigned or created by agents, and historical information linked to agents including details of past performance, reviews from purchasers and/or sellers relating to previous transactions, and experience with similar tasks. The agent network 120 may include, for example, or more control circuits such as one or more server computers. In some forms, the return management control circuit 101 may match characteristics of available return agents to purchaser preferences in order to select a return agent 75 suitable for the purchaser 90. Purchaser preferences may be provided to the return management control circuit 101 through a mobile application, website, a customer preference database connected to the control circuit, or any other manner of conveying preference information.

When the return agent 75 is assigned a retrieval task, he or she will be provided with information regarding the item to be retrieved, the location of the item, and in some forms, special retrieval or handling instructions. The return agent 75 also receives one or more temporary access codes for actuating a movable barrier operator 63 and/or return receptacle 70 in order to carry out the assigned retrieval task. The return management control circuit 101 may in some forms also be configured to provide the same access code(s) or complementary codes to one or more control circuits associated with the movable barrier operator 63, return receptacle 70, and/or delivery receptacle 68 so that the associated control circuits can compare the codes to codes sent by the return agent 75 and verify that access is to be granted to the agent. In other forms, the access code(s), complementary codes, or other information sufficient to verify access codes transmitted by the return agent 75 are initially stored in one or more memory modules associated with the movable barrier operator 63, return receptacle 70, and delivery receptacle 68 and then sent to return management control circuit 101 so that they can be assigned to the return agent 75.

When the return agent 75 is proximate the garage 60, he or she is able to activate their mobile device 76 to transmit the temporary access codes and obtain access to the item(s) to be returned. For instance, interacting with an interface of the mobile device 76 may transmit access codes or tokens to the movable barrier operator 63 and return receptacle 70, causing the garage door 61 to be raised by the movable barrier operator 63 and also causing the return receptacle 70 to unlock (in embodiments wherein the return receptacle 70 includes a lock). In alternative forms, a code may be first sent to the movable barrier operator 63 and then a different access code is separately sent to the return receptacle 70 upon a subsequent actuation of the mobile device 75. If desired, access codes may be automatically sent to the movable barrier operator 63 and/or return receptacle 70 when the return agent 75 is in a preset location (e.g., within a defined geofence or within a specific distance of movable barrier operator 63 and/or return receptacle 70). The agent's mobile device may in some forms control the movable barrier operator 63 and return receptacle 70 indirectly, such as through return management control circuit 101 or through another local or remote server, the internet, or other platform. In other forms, the agent's mobile device 76 may be configured to communicate directly with the movable barrier operator 63 and return receptacle 70.

Once the return agent 75 has accessed the return receptacle 70, the return agent may be prompted or required to scan or photograph the item to be returned (or one or more RFID tags, bar codes or QR codes, or another indicium associated with the item) or otherwise transmit information regarding the item to the return management control circuit 101 in order to confirm that the correct item is being retrieved. The return agent 75 may then exit the garage 60 and activate the movable barrier operator 63 to close the garage door 61. In some forms, the movable barrier operator or return management control circuit 101 may be configured to close the garage door 61 within a predetermined time of confirming that the return receptacle 70 has been accessed, or upon confirmation that the return agent 75 has exited the premises (by tracking the agent's mobile device 76, through sensors mounted within the garage 60, or other means). The return agent 75 then transports the item retrieved from the return receptacle 70 to the seller (or a facility or entity identified by the seller) in order to complete the return transaction. Upon completion of the return transaction, the return agent 75 may use their mobile device 76 to close out the retrieval task. In some forms, the mobile device 76 may automatically close out the assigned task once it is completed.

The return management control circuit 101 may in some forms also connect to a financial network 130, such as a banking network or credit card network, to cause the issuance of a refund to the purchaser 90 based on items retrieved by the return agent 75. The financial network 130 may be a part of retail partner network 110 in some forms and may be, for instance, incorporated into an e-commerce platform of the seller capable of issuing refunds and/or credits to purchasers and/or compensating return agents (either directly or through a separate administrative platform for return agents). The financial network 130 may include, for example, one or more control circuits such as one or more server computers. Refunds to users/purchasers/recipients making the returns may be issued, for example, at the time that the agent accesses the return receptacle 70, at the time the return agent exits the garage 60 and closes movable barrier 61, upon confirmation that the return agent has delivered the item to be returned to the seller or a facility or entity identified by the seller, or at some other time. The return system 100 may in some forms collect payment from the seller at the outset of the return transaction in order to make sure funds are available upon completion of the transaction. In other forms the seller submits a refund to the purchaser directly, avoiding the need for the return system 100 to collect and distribute money. In yet other forms, the return system is authorized to release funds held in escrow for the issuance of refunds. In some forms, the refund will be reduced by a specified amount in order to compensate return agent 75, the seller, and/or manufacturer or administrator of the return system 100 for the convenience of the return transaction.

Another system for accessing and controlling a movable barrier operator and associated devices is shown and described in connection with FIGS. 10A-10B of U.S. Pat. No. 11,055,942. While the system described in that application generally relates to delivery of merchandise to a purchaser, many of the same elements and concepts may be utilized to facilitate return of merchandise from the purchaser to the seller or another entity.

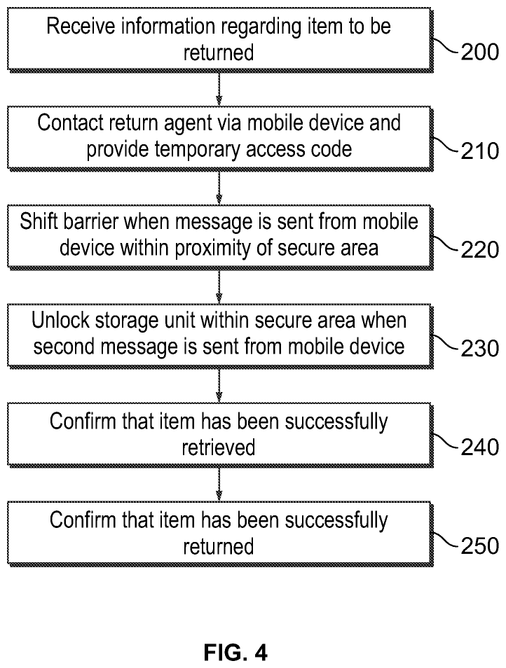

FIG. 4 shows one example of a method for carrying out a return transaction. At step 200, a system, network, computing device, or control circuit receives information regarding an item that is to be returned. This information may be provided by an individual requesting the return, for instance by manually entering information into a handheld device, website, or other instrument for initiating the return. Alternatively, the information regarding the item to be returned may be provided by selecting the item from a purchase history and selecting a return option, by scanning the item while using a mobile application set to a return configuration, by scanning the item in a designated return area or with a designated return scanner, or by other methods. Information also may be gathered about the device by scanning a bar code, QR code, RFID or Bluetooth® identification tag, etc.

Once an item to return has been identified, a return agent is contacted at step 210 and instructed to retrieve the item to be returned. If the return agent accepts the instruction, their mobile device is provided with temporary capability (e.g. via a code, token, credential, etc.) to gain access to the item. The agent may be, in some instances, an independent contractor, an employee of the seller, or even an affiliate of the purchaser. The agent may be identified, for instance, based on proximity to the site at which the item to be returned is located. The return system may alert return agents to the availability of a return transaction by, for instance, broadcasting a notice to all potential agents within a specified geographic area. The notice may be issued a single time, or may be broadcast continuously or periodically until accepted by a return agent. In some forms, the system may have an opportunity to reject the accepting agent upon identification of certain characteristics associated with the agent, such as poor past performance or lack of a particular resource such as a temperature-controlled return container or a padded/protective return container to prevent damage of a fragile item. The system may also be configured to consult a database containing information relating to potential return agents and then broadcast an alert or notice only to those agents that meet specific criteria.

At step 220, the agent sends a message from their mobile device directly or indirectly to a movable barrier operator capable of controlling access to a facility (such as a garage or warehouse) by shifting a barrier, and upon receipt of the message the movable barrier operator shifts the barrier to an open position to allow access to the interior of the facility. For instance, the message sent to the movable barrier operator may include a rolling code, certificate, digital token, and/or other information that may be received by the movable barrier operator, compared to information stored in a computer readable memory, and verified as a valid code for operating the barrier. Optionally at step 230, a second message sent from the agent's mobile device contains a second temporary access code configured to unlock or open a storage unit or other subsection within the facility, granting access to the returned item. In some embodiments, additional barriers or security devices may be moved or unlocked by additional access codes. In some embodiments, the temporary access code that shifts the movable barrier is the same access code that unlocks the storage unit. In some embodiments only a single message is sent by the agent's mobile device to both shift the movable barrier and unlock the storage unit, and the single message may include a single temporary access code configured to act upon both the movable barrier operator and storage unit lock, or alternatively the single message may include two separate access codes or portions of access codes that each act on one of the movable barrier operator and lock. At step 240 a message is sent or received by the return system confirming that the item has been successfully retrieved by the return agent, for instance in response to the agent scanning the item to be returned or a sensor or detector associated with the storage unit not detecting the presence of the item to be returned for a specified length of time.

At step 250, the system confirms that the item has been successfully returned, for instance by the return agent scanning the item at a return destination. In some methods, one or more steps may be eliminated or modified in order to simplify the process or limit the number of steps for which the return system is responsible. In addition, other steps may be added to increase security and provide other features.

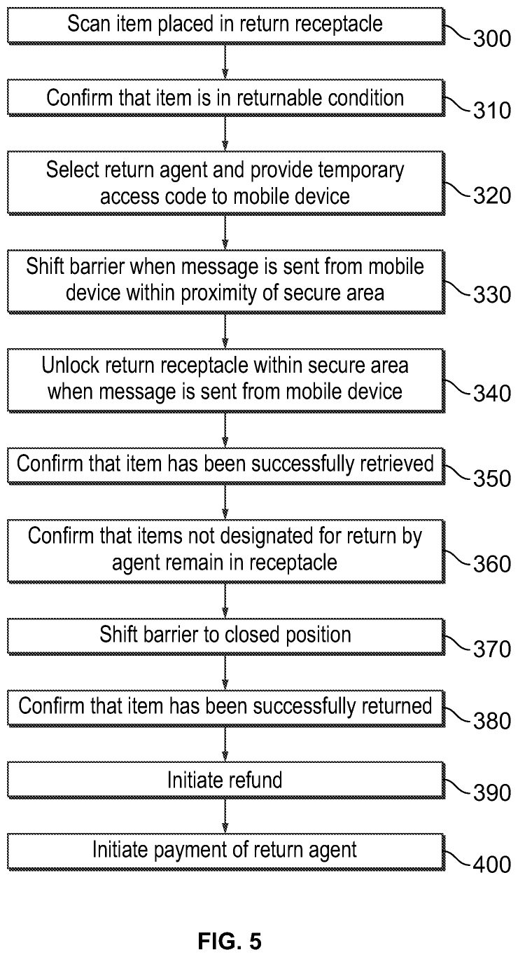

FIG. 5 shows another example method of facilitating return transactions. In the illustrated method, an item is placed in a return receptacle in order to initiate a return transaction at step 300. The item may be scanned at the return receptacle to determine its identity or characteristics. For instance, a bar code, QR code, RFID tag, or other identifier at the point of purchase may be scanned if still associated with the item. Alternatively, a user may be supplied with an identification tag to affix to the item, or the user may print an identification tag to affix to the item and then scan. In some forms, the item may be identified by scanning with a camera located in the return receptacle and use of image recognition software that matches images of the item to information regarding potential identities of the item.

In some specific embodiments, the return receptacle may also double as a delivery receptacle, for instance where a purchaser has entered into a subscription service where items are automatically delivered to the purchaser's garage. In some embodiments the purchaser's use or consumption of perishable items, for example, is tracked through an Internet of Things (IoT) system to determine when packaging is discarded into a trash receptacle or when the mass of certain products diminishes beyond a threshold level. As the system detects use of these items, replacement items are automatically ordered and delivered to the dual-purpose receptacle. Presence of an item in the dual-purpose receptacle for a predefined period of time may be deemed to be a rejection of the items and automatically trigger a return transaction.

At step 310 the system confirms that the item is in a condition in which it may be eligible for return to the seller. For instance, scanning of the item may in some forms not only identify the item, but also confirm that the item to be returned has not been damaged, destroyed, disassembled, consumed, or otherwise in a condition unsuitable for subsequent use, in whole or in part. In some forms, sensors other than those used to determine item identity are used to confirm that the item is in a suitable condition for return. For instance, if the item to be returned is produce or another type of food item, a piezoelectric mat or other weight sensor may confirm that the item has not been used up. Sensors, cameras, or other devices may also be used to continuously monitor the item until the item is retrieved, and locking of the return receptacle and monitoring of the lock can also be used to ensure that the item remains intact even after determining that it is in returnable condition.

If the item is determined to be in a returnable condition, the system then selects a return agent at step 320. The return agent may be selected by one or more different factors, including proximity to the return receptacle, number of other deliveries or returns scheduled within a predetermined geofence or other area surrounding the return receptacle, historical performance of the return agent, urgency of return (especially for perishable items), and other factors. The selected return agent is sent or assigned one or more temporary access codes usable to access the return receptacle and return the item. The temporary access codes may be, for instance, sent to and stored in a smartphone or other mobile device associated with the return agent. Instructions regarding where and when to retrieve the item are also transmitted to the return agent.

At step 330, when the return agent is within communication range of the return receptacle, or at least within range of a barrier securing an area surrounding the return receptacle, the return agent may activate the mobile device of the return agent to transmit an access code configured to cause a movable barrier operator to shift a barrier (such as a garage door) to permit the return agent to enter an area containing the return receptacle. The access code also may simultaneously trigger an unlocking operation of the return receptacle (step 340), although in some forms unlocking of the return receptacle may be a separate step and may involve the use of additional access codes and/or additional activations of the return agent's mobile device. Further, in some embodiments, a receptacle may not be utilized or not include a lock such that step 340 is not performed.

At step 350, the system confirms that the item has been successfully retrieved, for instance by detecting an absence of the item by one or more weight or optical sensors located in the return receptacle. The system may also confirm that items that were located in the receptacle but not designated for return have not been taken by the return agent, especially in cases where the receptacle acts as a dual purpose delivery and return receptacle (step 360).

Once retrieval of the item is accomplished, the return agent may shift the movable barrier to a closed position at step 370, which ensures that the area around the receptacle is again secured. In some forms, the system may be configured to automatically close the movable barrier when the return agent exits the area surrounding the return receptacle.

The system may also confirm that the item has been successfully returned to the seller, or another person or location designated by the seller, at step 380. This may involve the return agent and or the system receiving electronic confirmation from the seller has received the item, or may involve tracking of the return agent to a final destination.

In some forms, the system may initiate a refund at step 390. This may include transmitting a message to the seller indicating that a specific refund amount may be provided to the purchaser, or may involve directly sending payment to the purchaser and separately obtaining reimbursement for the refund from the seller. In some forms, the refund process may be completely left to the seller.

In some forms, the system may also initiate payment of the return agent at step 400. This may be a set fee or a portion of the refunded amount. In some forms, the payment of the return agent is managed by the seller.

Various operations are discussed above as being performed by the return management control circuit 101, retail partner network 110, agent network 120, and financial network 130. It will be appreciated that the operations may be performed by a different one of the return management control circuit 101, retail partner network 110, agent network 120, and financial network 130 than as described above. Further, two or more of the return management control circuit 101, retail partner network 110, agent network 120, and financial network 130 may cooperate to perform an operation discussed above. Further, one or more of the return management control circuit 101, retail partner network 110, agent network 120, and financial network 130 may be combined, such as a first server computer providing the operability of the return management control circuit 101 and a second server computer providing the operability of the retail partner network 110, agent network 120, and the financial network 130.

Uses herein of singular terms such as “a,” “an,” are intended to cover both the singular and the plural, unless otherwise indicated herein or clearly contradicted by context. For example, while in some instances references is made to an item, it should be understood that an “item” can comprise multiple related or unrelated items. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims.

1. A control circuit for facilitating a return of a product from a garage, the control circuit comprising:
communication circuitry configured to communicate with a sensor; and
a processor operatively connected to the communication circuitry, the processor configured to:
control the communication circuitry to receive a return request associated with a user account for returning a product, and data from the sensor indicating whether the product is in a designated return zone of the garage, wherein the garage further comprises a designated delivery zone;
authorize the return request in response to a determination of the product having been ordered using the user account and a determination that the product is in the designated return zone;
control the communication circuitry to receive a request for a return agent to retrieve the product from the designated return zone of the garage;
select the return agent to correspond to a future delivery to the designated delivers zone; and
control the communication circuitry to assign the return agent an access code to control a garage door operator of the garage to access the garage and retrieve the product, wherein the return agent causes the garage door operator to shift a garage door to an open state using the access code when the return agent is within communication range of the garage door operator, and wherein the access code or another assigned access code is further usable by a delivery agent to cause the garage door operator to shift the garage door to the open state to perform a delivery to the designated delivery zone.

2. The control circuit of claim 1 wherein the processor is configured to select the return agent by selecting a return agent scheduled to make additional deliveries within a specific area and time window.

3. The control circuit of claim 1 further comprising a memory configured to store data regarding a product ordered using the user account;
wherein the data from the sensor includes data representative of an image of the product captured by the sensor; and
wherein the processor is configured to determine whether the product was ordered using the user account based at least in part upon the data from the sensor representative of the image of the product corresponding to the data stored in the memory regarding the product ordered using the user account.

4. (canceled)

5. The control circuit of claim 1 wherein the garage further comprises a camera configured to capture image data within the garage.

6. The control circuit of claim 1 wherein the processor is configured to select the return ag ent via communication with an a ent network and the selection is based on obtained information selected from the group consisting of available return agents, locations of available return agents tasks assigned to return agents pre-planned delivery or retrieval routes assigned or created by return agents, details of past performance, reviews from purchasers or sellers relating to previous transactions and experience with similar tasks.

7. The control circuit of claim 1 wherein the processor is configured to determine whether the return is urgent, and wherein selecting the return agent to correspond to the future delivery to the designated delivery zone occurs only when the return is not urgent.

8. The control circuit of claim 1 wherein the processor is further configured to select the return agent to match a preference associated with the user account.

9. The control circuit of claim 1 wherein the access code associated with the return agent access code is automatically communicated to the garage door operator when the return agent is within a defined distance of the garage door operator.

10. (canceled)

11. (canceled)

12. The control circuit of claim 1 wherein the sensor comprises a camera of a portable electronic device and the data from the sensor comprises image data; and
wherein the processor is configured to determine whether the product is in the designated return zone of the garage based at least in part upon the image data.

13. The control circuit of claim 1 wherein the processor is configured to control the communication circuitry to receive the return request by receiving a request from a storage unit in the garage, the storage unit automatically transmitting the return request to the control circuit upon the product being positioned in the storage unit.

14. The control circuit of claim 1 wherein the communication circuitry is configured to communicate with a storage unit in the garage; and
wherein the processor is configured to control the communication circuitry to enable the return agent to control a lock of the storage unit to access the product in the storage unit.

15. The control circuit of claim 1 wherein the processor is configured to determine whether the product is in an acceptable condition for return based at least in part upon the data from the sensor; and
wherein the processor is configured to authorize the product return in response to:
the determination of the product having been ordered using the user account;
the determination that the product is in the designated return zone; and
the product being in the acceptable condition for return.

16. The control circuit of claim 1 wherein the communication circuitry is configured to communicate with the garage door operator, the garage door operator including the sensor; and
wherein the processor is configured to control the communication circuitry to receive, from the garage door operator, the data from the sensor indicating whether the product is in the designated return zone.

17. A method for facilitating a return of a product from a garage, the method comprising:
at a control circuit:
receiving, via communication circuitry of the control circuit, a return request associated with a user account for returning a product, and data from a sensor indicating whether the product is in a designated return zone of the garage, wherein the garage further comprises a designated delivery zone;
authorizing, via a processor of the control circuit, the return request in response to a determination of the product having been ordered via the user account and a determination that the product is in the designated return zone;
receiving, via the communication circuitry, a request for a return agent to retrieve the product from the garage;
selecting the return agent to correspond to a future delivery to the designated delivery zone; and
assigning, via the communication circuitry, the return agent an access code to control a garage door operator of the garage and retrieve the product, wherein the return agent causes the garage door operator to open a garage door using the access code when the return agent is within communication range of the garage door operator, and wherein the access code or another assigned access code is further usable by a delivery agent to cause the garage door operator to shift the garage door to the open state to perform a delivery to the designated delivery zone.

18. The method of claim 17 wherein the data from the sensor indicating whether the product is in the designated return zone includes data representative of an image captured by the sensor; and
determining, via the processor of the control circuit, whether the product is in the designated return zone based at least in part upon the data representative of the image captured by the sensor.

19. The method of claim 17 further comprising storing, in a memory of the control circuit, data regarding a product ordered using the user account;
wherein the data from the sensor includes data representative of an image of the product captured by the sensor; and
determining, via the processor of the control circuit, whether the product was ordered using the user account based at least in part upon the data from the sensor representative of the image of the product corresponding to the data stored in the memory regarding the product ordered using the user account.

20. (canceled)

21. The method of claim 17 wherein enabling the return agent to control the garage door operator comprises communicating an open command to the garage door operator.

22. The method of claim 17 wherein enabling the return agent to control the garage door operator comprises communicating a code to a mobile device of the return agent.

23. The method of claim 17 further comprising storing, via a memory of the control circuit, a product order history of the user account; and
determining, via the processor of the control circuit, whether the product was ordered using the user account based upon the product order history.

24. The method of claim 17 further comprising selecting, via the processor of the control circuit, the return agent from a plurality of return agents based at least in part upon a current location or a predicted future location of the return agent.

25. The method of claim 24 wherein selecting the return agent from the plurality of return agents further comprises selecting the return agent based upon a delivery schedule of the return agent.

26. (canceled)

27. (canceled)

28. The method of claim 17 wherein the sensor comprises a camera of a portable electronic device and the data from the sensor comprises image data; and
determining whether the product is in the designated return zone of the garage based at least in part upon the image data.

29. The method of claim 17 wherein receiving the return request comprises receiving the return request from a storage unit in the garage, the storage unit automatically transmitting the request to the control circuit upon the product being positioned in the storage unit.

30. The method of claim 17 further comprising enabling, via the communication circuitry of the control circuit, the return agent to open a lock of a storage unit in the garage.

31. The method of claim 17 further comprising determining, via the processor of the control circuit, whether the product is in an acceptable condition for return based at least in part upon the data from the sensor; and
wherein authorizing the product return comprises authorizing the product return in response to:
the determination of the product having been ordered via the user account;
the determination that the product is in the designated return zone; and
the product being in the acceptable condition for return.

32. The method of claim 17 wherein the garage door operator comprises the sensor; and
wherein receiving the data from the sensor comprises receiving the data from the garage door operator.

33. The method of claim 17 wherein receiving the return request and receiving the data from the sensor comprises receiving a first communication comprising the return request from a first device and receiving a second communication comprising the data from the sensor from a different, second device.

34. A non-transitory computer readable medium storing instructions that, when executed by a processor of a control circuit, cause performance of operations comprising:
receiving a return request associated with a user account for returning a product, and data from a sensor indicating whether the product is in a designated return zone of a garage, wherein the garage further comprises a designated delivery zone;
authorizing the return request in response to a determination of the product having been ordered via the user account and a determination that the product is in the return zone;
receiving a request for a return agent to retrieve the product from the garage;
selecting the return agent to correspond to a future delivery to the designated delivery zone; and
assigning the return agent an access code to control a garage door operator of the garage and retrieve the product, wherein the return agent causes the garage door operator to open a garage door using the access code when the return agent is within communication range of the garage door operator, and wherein the access code or another assigned access code is further usable by a delivery agent to cause the garage door operator to shift the garage door to the open state to perform a delivery to the designated delivery zone.
